(19) United States
(12) Patent Application Publication
(10) Pub. No.: US 2026/0175460 A1
(43) Pub. Date: Jun. 25, 2026

(54) RAZOR BLADES

(71) Applicant: The Gillette Company LLC, Boston, MA (US)

(72) Inventors: Kenneth James SKROBIS, Maynard, MA (US); Allen Chu CHANG, Middleton, MA (US); Derek Michael SMITH, Arlington, MA (US); Jonathan Raymond PETRIE, Braintree, MA (US)

(21) Appl. No.: 19/426,365

(22) Filed: Dec. 19, 2025

Related U.S. Application Data
(60) Provisional application No. 63/736,959, filed on Dec. 20, 2024.

(51) Int. Cl. B26B 21/60; C09D 1/00; C09D 183/08

(52) U.S. Cl. CPC B26B 21/60; C09D 1/00; C09D 183/08

(57) ABSTRACT

A razor blade with a sharpened cutting edge with an outer bonding surface. A phosphonate polysiloxane composite layer deposited on the outer bonding surface forming an outermost layer of the sharpened cutting edge. The phosphonate polysiloxane composite layer is composed of one or more layers. The phosphonates are covalently bonded to the outer bonding surface. The siloxanes are covalently bonded to the phosphonates and in some applications are also covalently bonded to the outer bonding surface. The siloxanes are a reactive silicone polymer, bonded to the phosphonates or outer bonding surface creating branches, mild crosslinking or even heavily crosslinked layers. The phosphonate polysiloxane composite may be formed through the use of thermal, UV exposure, IR exposure, a combination of thermal, UV, and or IR, as well as e-beam, ion-beam, or other ionization source.

### FIELD OF THE INVENTION

The present invention relates generally to coating of substrates, and more particularly to improved coatings on razor components, such as razor blades.

### BACKGROUND OF THE INVENTION

Typical razor blades used for shaving are commonly created by grinding a sharp bevel onto a martensitic steel substrate. A hard coating is often applied to strengthen the blade edge and to create a tip shape appropriate for shaving. In addition to the hard coating, one may apply an outer coating that may improve the shaving experience by reducing the cut force in comparison to the uncoated blade edge.

Due to evolving technology in terms of blade edges, there is an ever existing need to improve upon coatings that may work in synergy with the blade edge. As such, there is a need for improved coatings on cutting edges, such as blade edges, that exhibit desirable characteristics (e.g., cutting force, surface energy, minimal nicking of the skin, etc.) for uses such as hair cutting, that minimize softening and potential damage to the substrate, e.g. mechanical damage, and that utilize cost-effective and time-effective manufacturing processes.

### SUMMARY OF THE INVENTION

Razor blades described herein may comprise a sharpened cutting edge with an outermost layer created by deposition of a lubricious, phosphonate polysiloxane composite layer. An outer surface of the sharpened cutting edge may be coated and/or treated, such that bonding of the coating material is facilitated and/or optimized, ensuring it survives during shaving.

In accordance with an aspect of the present disclosure, a razor blade has a sharpened cutting edge with an outer bonding surface. A phosphonate polysiloxane composite layer is deposited on the outer bonding surface forming an outermost layer of the sharpened cutting edge. The phosphonate polysiloxane composite layer comprises a coating applied to achieve both durability and low cut forces.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a front view of a razor system comprising a handle and a razor cartridge in accordance with the present disclosure.

FIG. 2 is a side view of a symmetric substrate for a razor blade, in accordance with the present disclosure.

FIG. 3 is a perspective view of a tip portion of a symmetric substrate for a razor blade, in accordance with the present disclosure.

FIG. 4 is a diagrammatic view illustrating a substrate of a razor blade, in accordance with the present disclosure.

FIG. 5 is a side view of a razor blade with a symmetric substrate and a coating material on the tip portion and a section of a body portion, in accordance with the present disclosure.

FIG. 6 is a side view of a razor blade along with a magnified portion of the tip with a symmetric substrate and a coating material on the tip portion and a section of a body portion, in accordance with the present disclosure.

FIG. 7 is a detailed view of a tip portion of a razor blade with a symmetric substrate and a multi-layer coating material, in accordance with the present disclosure.

FIG. 8 is a method for making a razor blade in accordance with the present disclosure.

FIG. 9 is a chemical reaction of phosphonate and siloxane to create the phosphonate polysiloxane composite layer in accordance with the present disclosure.

FIG. 10 is a representation of the coated substrate with a phosphonate polysiloxane composite layer.

FIG. 11A is a side view of a razor blade with an asymmetric substrate and a coating material, in accordance with the present disclosure.

FIG. 11B is a side view another razor blade with an asymmetric substrate and an asymmetric coating, in accordance with the present disclosure.

FIG. 12 is a magnified view of a razor blade tip having an asymmetric substrate and an asymmetric coating, in accordance with the present disclosure.

FIG. 13 shows a wool cut force comparison for an untreated substrate compared to razors made in accordance with the present disclosure.

FIG. 14 is a glossary of terms with their identifying number.

### DETAILED DESCRIPTION OF THE INVENTION

For purposes of the following detailed description, it is to be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, the use of the singular includes the plural and plural encompasses singular, unless specifically stated otherwise. In addition, in this application, the use of “or” means “and/or” unless specifically stated otherwise, even though “and/or” may be explicitly used in certain instances.

The term “asymmetric blade,” as used herein, means a razor blade defined by a substrate having a first portion comprising a blade body and a second portion comprising a tip portion wherein a split line passes through a tip of the tip portion, extends through the first and second portions and separates the second portion into generally asymmetric first and second sections either due to an shape of the substrate or due to the coating layer. The outer surface of the first section of the second portion is asymmetric with regards to the outer surface of the second section. The outer surface of the first section of the second portion may function as a skin-contacting surface, and the outer surface of the second section may function as a hair-cutting surface.

As used herein, the term “coating” means a covering, including a monolayer, a free film, an impregnation, or the like, that is applied to an object or substrate, such that the covering may be continuous, contiguous, discontinuous, may have a single or varying thicknesses, or may exist in a single or multiple planes.

As used herein, a “razor blade” means a substrate shaped to form a tip, the substrate being either symmetrical or asymmetrical, and a coating layer that may be symmetrical or asymmetrical, the coating layer being either a monolayer or a multi-layer. As discussed below, the coating layer may be different for different portions of the substrate.

A “split line,” as used herein, means a line extending through the tip of the tip portion of the razor blade.

As used herein, a “substrate” means the substance or material acted upon by the deposition process(es) in the present disclosure. Nonlimiting examples of a substrate include a metal, such as e.g. steel or stainless steel, an alloy, or a ceramic, such as chromium, platinum, boron, chromium diboride, titanium, titanium diboride, a ceramic comprising different metals or metal oxides forming at least a portion of the outer surface area, sand, limestone, glass, glass composites, silicate, silicate composites, vanadium, aluminum, tin, tantalum, zirconium, niobium, magnesium, manganese, iron, cobalt, copper, silver, zinc, hafnium, tungsten, molybdenum, or nickel, and oxides, nitrides, and oxynitrides thereof. A substrate may exhibit uniform widths along a length or may vary in width such as an undulating blade. The substrate may be as described in U.S. patent application Ser. No. 17/306,685, and US Pat. Appl. No. 2024/0042636 Or a diamond coated cutting element as described in U.S. patent application Ser. No. 17/965,998.

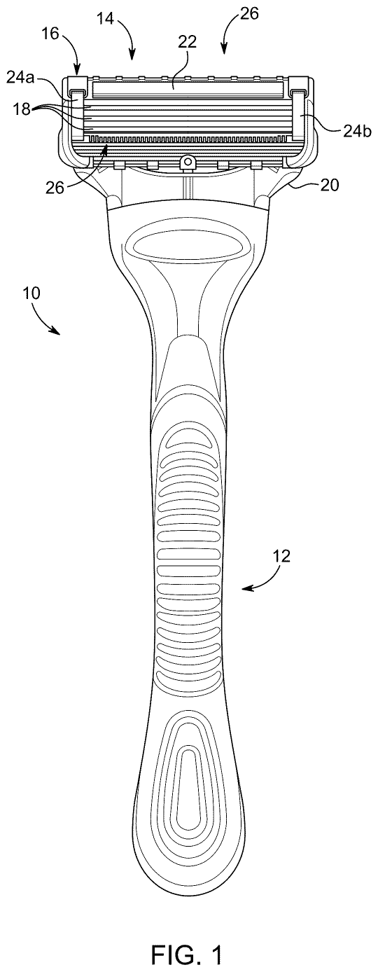

With reference to FIG. 1, a shaving razor system 10 comprises a handle 12 and a razor cartridge 14. The razor cartridge may be constructed as described in U.S. patent application Ser. No. 17/161,822. Examples of handles may be found in U.S. patent application Ser. No. 17/497,303, U.S. patent application Ser. No. 17/572,868. In some examples, the razor cartridge 14 may be detachably mounted to the handle 12 with a connector 20, as shown, and in other examples, the razor cartridge 14 may be attached permanently to the handle 12. The razor cartridge 14 may pivot relative to the handle 12. The razor cartridge 14 may include a cartridge housing 16 having one or more razor blades 18. Although three blades are shown in FIG. 1, it is understood that any number of blades, more or less, may be mounted within the razor cartridge 14. The razor blades 18 may be mounted within the cartridge housing 16 and secured with clips 24a and 24b as shown. The cartridge housing 16 may further comprise a cap 22 located near a back of the cartridge housing 16 and one or more guard structures 26 located near a front of the cartridge housing 16. The cap 22 may comprise one or more lubrication members (not labeled). The cartridge may have lubrication members such as those described in U.S. Pat. No. 10,315,323, or U.S. Pat. No. 6,301,785. The cartridge may have one or more guard structures such as those described in U.S. Pat. No. 4,587,729.

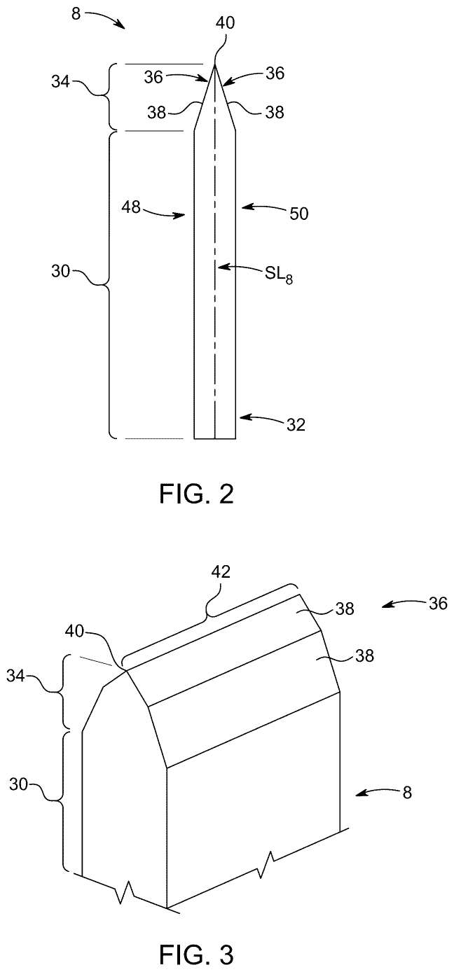

FIGS. 2 and 3 are side and perspective views of a substrate 8 which has been formed to have a tip 40 in accordance with aspects of the present disclosure. substrate 8 may comprise a first portion with a blade body 30 and a second portion with a tip portion 34. The blade body 30 may comprise a base 32, and the tip portion 34 may comprise flanks 36 that converge at a sharpened tip 40 to define a sharpened cutting edge 42 as shown in FIG. 3, which performs the cutting of hair. The flanks 36 may each comprise one or more bevels or facets 38. The substrate of FIG. 2 is described in more detail in U.S. Pat. No. 9,751,230. As shown in FIG. 2, a split line SL₈, crossing through the tip 40, that may or may not coincide with a centerline (not shown), divides the substrate. The split line SL₈ may be generally parallel with generally planar, outer surfaces (not labeled) of the blade body 30. One outer side 48 (also referred to herein as a first outer side) of the substrate 8 is disposed opposite the split line SL₈ with respect to the other outer side 50 (also referred to herein as a second outer side). As used herein, the terms “first” and “second” (i.e., to designate structures such as sections) are for reference only and are not intended to be limiting.

At least a portion of one outer side of the substrate 8, e.g., the first outer side 48, may define a skin-contacting surface, and at least a portion of the other outer side, e.g., the second outer side 50, may define a hair-cutting surface.

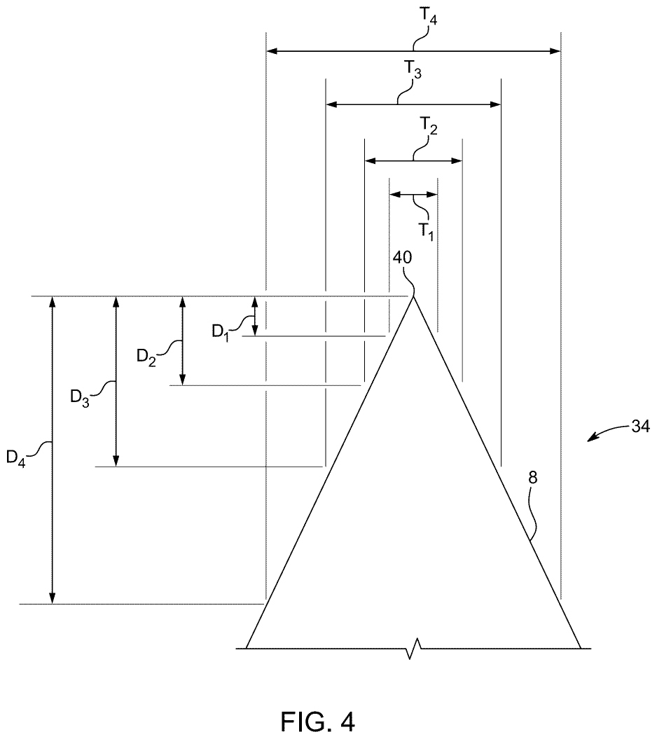

FIG. 4 is a diagram of a tip portion 34 of a substrate 8 exemplifying potential thicknesses at set distances from the sharpened tip 40. The substrate 8 may comprise a thickness T₁ of between about 1.3 and 2.0 micrometers measured at a distance D₁ of four micrometers from the sharpened tip 40, a thickness T₂ of between about 2.3 and 3.5 micrometers measured at a distance D₂ of eight micrometers from the sharpened tip 40, a thickness T₃ of between about 3.8 and 6.4 micrometers measured at a distance D₃ of sixteen micrometers from the sharpened tip 40, and/or a thickness T₄ of between about 9.3 and 16.2 micrometers measured at a distance D₄ of forty micrometers from the sharpened tip 40. Alternatively, or in addition, the substrate 8 may comprise a ratio of thickness T₁ measured at four micrometers to the thickness T₂ measured at eight micrometers of at least 0.55, and/or a ratio of thickness T₁ measured at four micrometers to the thickness T₃ measured at sixteen micrometers of at least 0.28. Additionally, measurements for the substrate inclusive of both the tip portion and the body are stated below in both widths and based on angles. One of ordinary skill in the art would be able to translate between the two based on trigonometry and process teachings such as those found in U.S. Pat. Nos. 4,916,817A, 4,807,401A. The substrate may exhibit a thickness of between 1 and 2 micrometers at a distance of 5 micrometers from the tip, between 2 and 10 micrometers at a distance of 10 micrometers from the tip, between 2 and 10 micrometers at a distance of 20 micrometers from the tip, between 5 and 15 micrometers at a distance of 30 micrometers from the tip, between 5 and 15 micrometers at a distance of 40 micrometers from the tip, between 7.5 and 20 micrometers at a distance of 50 micrometers from the tip, between 15 and 30 micrometers at a distance of 100 micrometers from the tip, between 20 and 45 micrometers at a distance of 150 micrometers from the tip, between 25 and 55 micrometers at a distance of 200 micrometers from the tip, between 45 and 65 micrometers at a distance of 250 micrometers from the tip, between 50 and 75 micrometers at a distance of 300 micrometers from the tip, between 55 and 100 micrometers at a distance of 350 micrometers from the tip, between 55 and 100 micrometers at a distance of 400 micrometers from the tip. The substrate may have more than one facet such as two facets, three facets, four facets each having an included angle. In an embodiment, the substrate may have three or more pairs of facets; each pair of facets having an included angle. In an embodiment, the substrate may have pairs of facets forming the following included angles: 14-25 degrees by the two facets closest to the tip, an included angle of 12-19 degrees by the facets adjacent to the those closest to the tip followed by an included angle of 4-12. If the substrate only has two pairs of facets, then the included angles may be 14-25 degrees by the facets closest to the tip followed by an included angle of 4-12 degrees by the adjacent facets. Due to grinding, facets may be continuously grounded or may be distinct.

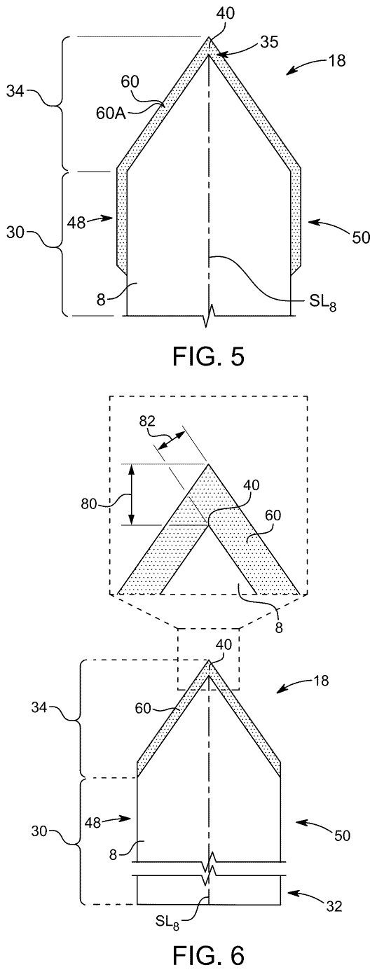

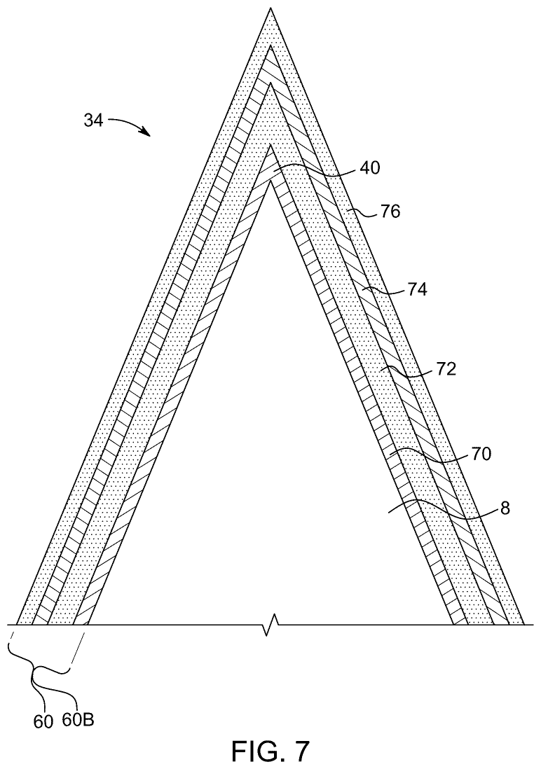

As shown in FIGS. 5, 6 and 7, the razor blades 18 may comprise a coating 60 disposed substantially on at least a portion of the first outer side 48 and the second outer side 50 of the substrate 8. The coating 60,60A may comprise a single layer, as shown in FIG. 5, or may comprise two or more layers as shown in FIG. 7 labeled 60B. The coating 60,60B of FIG. 7 may include one or more layers, in which each layer comprises one or more materials. In the examples shown in FIGS. 5-7, the coatings 60 may generally conform to and/or mirror an outer shape of underlying portions of the substrate 8 and may comprise a substantially uniform thickness.

In the example shown in FIG. 6, the coating 60 is depicted as extending along the first outer side 48 and the second outer side 50 of the substrate 8 from the sharpened tip 40 toward the base 32. In some examples, the coating 60 may stop short of the blade body 30 and/or the base 32, and in some particular examples, the coating 60 may be disposed substantially only on the tip portion 34 of the substrate 8, for example as shown in FIG. 6. In other examples, the coating 60 may be disposed on the tip portion 34 of the substrate 8 and at least a portion of the blade body 30, for example as shown in FIG. 5. In some particular examples (not shown), the coating 60 may extend from the tip region 34 all the way to the base 32. On an asymmetric razor blade (not shown), the coating 60 may be disposed only on the first outer side 48 or the second outer side 50. In other aspects (not shown), the coating 60 may be disposed on the first and second outer sides 48 and 50, but may extend different distances along the first and second outer sides 48 and 50. Prior to insertion into a cartridge, a coated substrate may be attached to a support member such as those described in U.S. Pat. No. 5,823,082.

The coating, either single layer or multi-layer, may have an aspect ratio (a) to (b), as shown in the inset in FIG. 6, in which (a) is a first thickness 80 from a tip 40 defined by the a coating 60 (which may define the outermost layer) to the sharpened tip 40 of the substrate 8, and (b) is a second thickness 82 from an outer surface (not labeled) of the coating 60 to an underlying surface (not labeled) of the substrate 8. The thickness 82 may be measured at a distance of four micrometers from the sharpened tip 40 (e.g., see distance D₁ in FIG. 4). In some examples, the aspect ratio (a) to (b) may be at least about 1.5:1, at least 2:1, or at least 2.5:1, ±0.5 for (a). In some particular examples, the aspect ratio (a) to (b) may be up to 3.5:1, and in other particular examples, the aspect ratio (a) to (b) may be up to 4:1. In general, a higher aspect ratio translates to a sharper cutting edge and a lower cutting force.

FIG. 7 provides a detailed view of a tip region 34 of a substrate 8 with a multi-layer coating 60,60B. The multi-layer coating may comprise of any possible combination in any potential combination of the following layers: an interlayer 70, a hard coating layer 72, an overcoat layer 74, and an outer layer 76. The layers are labeled for ease of use in terms of their traditional orientation. However, it is contemplated that an outer layer may be placed closer in proximity to a substrate versus an interlayer or that any of the layers may be stacked using a particular layer more than once in forming the multi-layer coating. As shown, the coating 60B comprises two or more layers, including one or more of an interlayer 70, a hard coating layer 72, an overcoat layer 74, and an outer layer 76.

The coating layer material may be adhered directly or indirectly to the substrate. The coating layer material may be deposited as a composite layer. In an embodiment, the two sides of the razor blade may generally perform different functions (e.g., a bottom side that contacts the skin and a top side that performs cutting of the hair, in which both sides perform cutting of the hair with the top side (e.g., away from the skin) having a larger influence).

The interlayer 70 may be used to facilitate bonding of the hard coating layer 72 to the substrate 8. Examples of suitable materials for the interlayer 70 may include chromium, niobium, titanium, and chromium-containing material(s). A particular interlayer is made of niobium greater than about 50 angstroms and preferably up to about 500 angstroms thick. In some examples, the interlayer 70 may have a thickness from about 50 angstroms to about 350 angstroms.

The hard coating layer 72 may provide improved strength, corrosion resistance, and shaving ability and may be used to obtain a desired tip shape. The hard coating layer 72 may be made from fine-, micro-, or nano-crystalline carbon-containing materials (e.g., diamond, amorphous diamond, nano-crystalline diamond, or diamond-like-carbon (DLC)), nitrides (e.g., boron nitride, niobium nitride, chromium nitride, zirconium nitride, or titanium nitride), carbides (e.g., silicon carbide), oxides (e.g., alumina, zirconia), borides (e.g. magnesium aluminum boride) or other ceramic materials (including nanolayers or nanocomposites). The carbon-containing materials may be doped with other elements, such as Tungsten, Titanium, Silver, Silicon, Chromium, Boron, Silicon, Nitrogen, Oxygen, various metals, such as Copper, Niobium, Nickel, Molybdenum, Tantalum, and combinations thereof. Doping and including these additives may occur, for example, during application by sputtering. The materials may also incorporate hydrogen, e.g., hydrogenated DLC. Preferably, the hard coating layer 72 is made of diamond, amorphous diamond, or DLC. Examples may be found in U.S. Pat. No. 11,691,308. A particular example includes DLC up to about 3,000 angstroms thick, preferably from about 500 angstroms to about 1,500 angstroms thick. DLC layers and methods of deposition are described in U.S. Pat. No. 5,232,568. As described in the “Handbook of Physical Vapor Deposition (PVD) Processing,” “DLC is an amorphous carbon material that exhibits many of the desirable properties of diamond but does not have the crystalline structure of diamond.”

The overcoat layer 74 may optionally be used to further modify a tip of the hard coated edge, to reduce a tip rounding of the hard coated edge and to facilitate bonding of the outer layer 76 to the hard coating 72, while still maintaining the benefits of both. The overcoat layer 74 is preferably made of a chromium-containing material, e.g., chromium or chromium alloys or chromium compounds that are compatible with the hard coating 72 and the outer layer 76, e.g., CrPt, or other ceramics including, for example and without limitation, metal oxides, carbides, nitrides, or borides such as SiO₂, Al₂O₃, ZrO₂, TiO₂, SnOₓ, TiOₓ, and similar oxides, along with Al-doped ZnO, and similar mixed oxides to increase photocatalytic properties. Other potential examples may be found at U.S. Pat. No. 9,327,416.

A particular overcoat layer 74 is chromium about 100-200 angstroms thick. The overcoat layer 74 may comprise material(s) similar to the interlayer 70 and/or the hard coating layer 72, such as niobium or boron. In some examples, the overcoat layer 74 may have a thickness of from about 10 angstroms to about 500 angstroms, preferably from 20 angstroms to 500 angstroms such as, e.g. 40 angstroms, 50 angstroms, 80 angstroms, 90 angstroms, 100 angstroms, 120 angstroms, 150 angstroms, 200 angstroms, 250 angstroms, 300 angstroms, 350 angstroms, 400 angstroms, 450 angstroms or 500 angstroms.

The outermost layer 76 may be used to, for example, provide reduced friction. The outermost layer 76 is a phosphonate polysiloxane composite layer. The phosphonate polysiloxane composite layer is covalently bonded to the overcoat layer and to itself wherein one or more molecules of phosphonates may be bonded to the overcoat layer, the substrate, siloxanes, and combinations thereof and wherein one or more molecules of siloxanes may be bonded to the overcoat layer, the substrate, phosphonates, and combinations thereof. In some embodiments, the outermost layer may comprise less than 1 percent by weight, more specifically less than 0.1 percent by weight, and in particular no or substantially no polytetrafluoroethylene (PTFE) or any other perfluoro- or a polyfluoroalkyl substance (PFAS).

In an embodiment, at least one additional layer of material is disposed between the sharpened cutting edge and the outermost layer selected from: (i) diamond, amorphous diamond, nanocrystalline diamond, or diamond-like-carbon (DLC); or (ii) chromium, platinum, boron, chromium diboride, titanium, titanium diboride, vanadium, aluminum, silicon, tin, tantalum, zirconium, niobium, magnesium, manganese, iron, cobalt, copper, silver, zinc, hafnium, tungsten, molybdenum, or nickel, and oxides, nitrides, and oxynitrides thereof. In one example, the one or more additional layers of material may comprise chromium. In one particular example, the additional layers may comprise a layer of niobium, a layer of DLC, a layer of chromium, and an outermost phosphonate polysiloxane composite layer, as described herein.

It has now been discovered that by providing on the cutting edge of a safety razor blade a thin layer or a coating comprising a combination of one or more phosphonates and one or more siloxanes combined in a particular matter, one can achieve a highly durable lubricious outermost layer. Furthermore, this combination of phosphonate and siloxane can be achieved without the use of an additional catalyst that may leave residual impurities.

As stated above, the outermost layer comprising phosphonates and siloxanes may extend over the entire substrate wedge faces back from the ultimate edge or even farther, or it may cover only a portion of one or more facets such as the final facet. Additionally, in an embodiment wherein different portions of the substrate comprise different layers, the outermost layer may contact two different layers such as an overcoat layer and a hard coating layer at different locations along one or more sides of the substrate.

It has been discovered that by first providing a layer of well bonded phosphonate followed by a layer of siloxane polymer made reactive via thermal and or photonic energy, one can create a razor having a layer of siloxane attached to the substrate and to the well bonded phosphonates that creates a durable and lubricious coating on the substrate.

Without being bound by theory, it is believed that utilizing phosphonate as an adhesion promoter, or coupling agent, allows one to create a layer of siloxane that is bonded covalently to both the substrate and the phosphonate. It is believed that the activation of reactive groups in the phosphonates and siloxanes such as, e.g. alkenyls which may comprise e.g. vinyls and acrylates during the curing process allows for the creation of the phosphonate polysiloxane composite layer. This is believed to be due to the creation of reactive sites such as vinyls during the curing process which may then interact with the siloxane to create crosslinking. Furthermore, if the siloxane is made reactive via thermal and or photonic energy, such a bonded layer can be created without the use of an additional catalyst component.

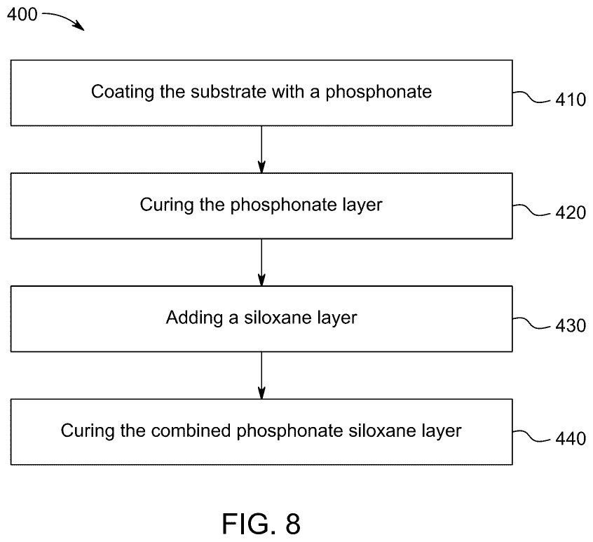

As shown in FIG. 8, the process of coating the blades 400 may comprise the steps of 1. Coating the substrate with a phosphonate (410), 2. Curing the phosphonate layer (420), 3. Adding a siloxane layer (430), and 4. Curing the combined phosphonate siloxane layer (440). Optionally, steps 3 and 4 may be repeated as needed.

To form a phosphonate polysiloxane layer without the use of catalysts, it has been found that the layers may be bonded thermally and/or through the application of light including e.g., visible light, high intensity light, through the application of photonic energy in the ultraviolet (UV) spectrum, or through the application of e-beam, ion-beam, or other ionization sources, or a combination thereof. In an embodiment, the environment comprises substantially zero oxygen gas, such as up to 1% oxygen, e.g. less than 0.5% or less than 0.05% oxygen. UV Curing may be done at a wavelength between 150-400 nm for a duration of up to 100 hours, e.g. curing may be done at a wavelength between 170 and 300 nm for a duration between 1 minute and 100 hours.

The coated blades may be cured, preferably in a non-oxidizing atmosphere (e.g. an inert gas such as nitrogen or argon, or in vacuum) at a temperature between, for example, 40° C. and 400° C., preferably 100° C. to 300° C. for a duration of, for example, 1 to 180 minutes, preferably up to 120 minutes, more preferably 45 minutes.

The phosphonate layer may be added by any known method including spraying and dipping the substrate with a phosphonate comprising fluid. The fluid can contact the substrate for at least 1 second, such as, for example, at least 5 seconds, at least 10 seconds, at least 30 seconds, at least 1 minute, at least 5 minutes, at least 10 minutes, at least 20 minutes, or at least 30 minutes. In certain embodiment of the method, the fluid can contact the substrate for a time in a range of 1 second to 40 minutes, such as, for example, 2 seconds to 10 minutes, 5 second to 10 minutes, 5 seconds to 5 minutes, 5 seconds to 2 minutes, or 10 seconds to 30 seconds. The fluid can react with the substrate during the contact time. In certain embodiments of the method, the phosphonate comprising fluid can contact the substrate comprising an overcoat for up to 4 days.

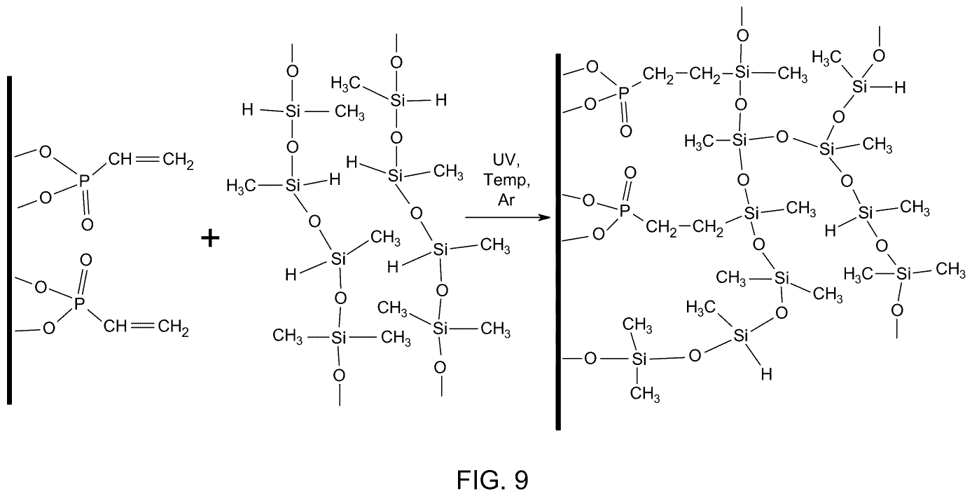

Contacting the substrate with the phosphonate comprising layer can form a phosphonate functionalized layer on the substrate as shown in FIG. 9. For example, oxide (e.g., aluminum oxide, titanium oxide, chromium oxide, or other oxide) present on a surface of the substrate can be modified by the phosphonate containing acid within the fluid and form a phosphonate-bonded functionalized layer on at least a region of the substrate. In various embodiments, the phosphonate group is bonded to the substrate through at least one P—O-metal bond. The phosphonate functionalized layer can improve corrosion performance of the substrate and can improve adherence of additional coatings to the substrate surface or metallic oxide layer.

The phosphonate polysiloxane layer addition process may be done in a temperature range between 200 and 350 degrees Celsius. The phosphonate polysiloxane layer addition process may use a cure utilizing ultraviolet radiation with or without added heat.

As the curing proceeds, the strength of the adherent bond to the cutting edge increases and the physical and chemical structure of the coating gradually changes, reaching optimal properties for shaving purposes at some stage during the curing reaction. Further oxidation results in a gradual decrease of the desirable coating properties and finally results in a coating which produces no detectable improvement in shaving characteristics.

In an embodiment, after anaerobic reactive bonding, O₂ and H₂O can be added to the ambient to encourage small amounts of additional cross-linking of the thin siloxane variant coating. Without being bound by theory, it is believed that this ambient will encourage the Si—H bonds to form Si—OH bonding which through thermal dehydration reactions can result in additional Si—O—Si bonding and x-linking or additional dehydration bonding with substrate-OH groups. In an embodiment, Siloxane may be added in multiple steps allowing for a curing process to occur between additions of Siloxane. Without being bound by theory, and as stated above, the curing can create newly reactive sites in the phosphonate polysiloxane composite layer. The addition of more siloxane and an additional curing step may strengthen the attachment of the phosphonate polysiloxane layer within itself through crosslinking and to the other layers of the razor such as the substrate and the overcoat layer.

In an embodiment, one may apply a final overcoat layer, from either vapor deposited or liquid coat, of an additional “small reactive siloxane molecule” (single-site reactive molecule, monomer, oligomer, low molecular weight polymer or mixture), applied to any remaining or newly created reactive sites in the Siloxane Variant coating or remaining reactive sites on the substrate. The resultant thin adherent coating, which is given mechanical support throughout its extent by the underlying blade, reduces the pull during the shaving operation and increases the ease of shaving.

As shown in FIG. 9 by coating the substrate according to the steps described in FIG. 8, it has been found that one can create a razor blade having a lubricious phosphonate polysiloxane composite outermost layer.

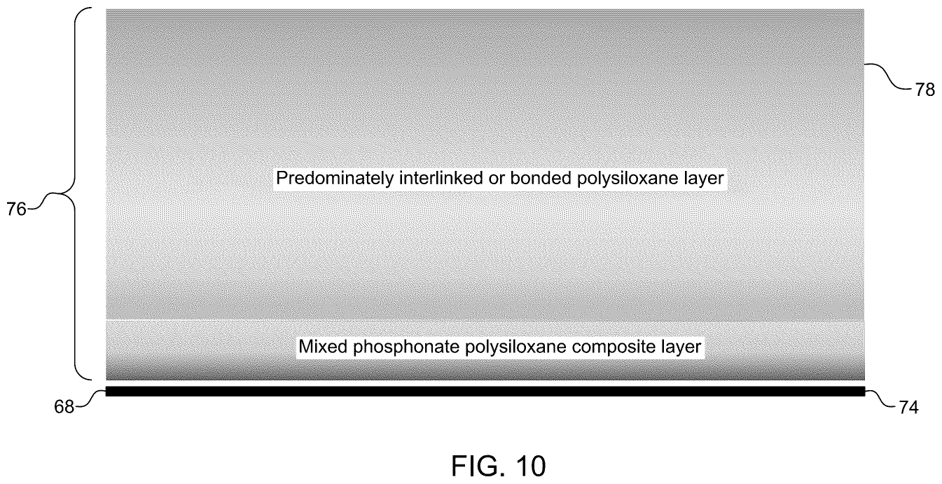

Without being bound by theory, it is believed that the advantage in phosphonate polysiloxane composite outermost layer in part derives from the gradient nature created by the process conditions which allow for greater adhesion of the composite layer to the substrate. As shown in FIG. 10, the composite layer may be shown as a composite gradient wherein the outer layer, 76, exhibits or comprises a high concentration of phosphonates with some siloxane bonding at the overcoat layer, 74, or at the interface 68 with the substrate and minimal or no phosphonates, but a high percentage of siloxanes, near the outer surface of the outer layer 78.

As used herein, the term “phosphonate” refers to phosphorus compounds that comprise a phosphorous atom coordinated with three oxygen atoms. One of the three oxygen atoms can be coordinated to the phosphorous atom by a double bond. A phosphonate does not comprise phosphoric acid (H₃PO₄). For example, a phosphonate can comprise the general Formula (I), wherein R₁, and R₂ are individually selected from hydrogen, an alkyl, or an aryl group and R₃ consists of a functional group attached to the phosphorus by a carbon atom. As such, R₁, R₂, and R₃ can be the same or can be different groups. R₃ can also include a multitude of different functional groups including vinyl, epoxide, and acrylate, among others, and in some applications, even a simple alkyl phosphonate can have a siloxane molecule or polymer covalently bonded too.

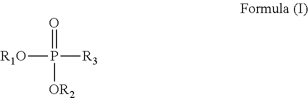

An example of a suitable phosphonate molecule according to the invention is vinyl phosphonate which has the following composition:

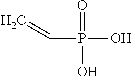

Other suitable phosphonates may include without limitation, phosphonates derived from vinyl phosphonic acid, dimethyl vinylphosphonate, diethyl vinylphosphonate, or other alkoxy vinylphosphonate, or acrylate-based phosphonates, or epoxide-based phosphonates, or in some cases alkyl-based phosphonates.

Additionally, it is believed that increasing the surface coverage of the substrate with molecules containing vinyl functional groups enhances one or both of the mechanical and chemical durability of added siloxanes. The increase in these molecules may be done with the addition of vinyl trichlorosilane, vinyltrimethoxysilane, vinyltriethoxysilane, or other alkoxyvinlysilane that may be included in addition to the phosphonate. In an embodiment the other molecules with vinyl groups are used as a substitute for the phosphonates.

In an embodiment, an alkyl phosphonate can be added to the vinyl phosphonate and or vinyl siloxane to create additional coverage and added reactive sites for the siloxane to bond, or as the sole phosphonate coupling agent.

Additionally, one may utilize acrylate phosphonates (such as 11-phosphonoundecyl acrylate) or epoxide phosphonates (such as epoxymethyl dimethyl phosphonate or epoxypropyl dimethyl phosphonate) as a precursor to the addition of the siloxane. Acrylates are highly reactive with UV relative to vinyl groups alone and are compatible with the addition and covalent bonding of Siloxane Variants. Epoxides have a wide variety of reactions that can take place to covalently bond a larger siloxane coating (such as HO-terminated or containing Siloxane Variants, amine-terminated or containing Siloxane Variants, or others).

Additionally, one may utilize silane-based coupling agents in conjunction with phosphonate-based coupling agents followed by the lubricious reactive siloxane. Alternatively, one may utilize mixed or multiple reactive end group coupling agents of either or both phosphonates or siloxanes.

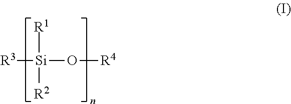

The linear siloxane variants are selected from compounds of formula (I).

R₁ and R₂ independently from each other represent H, a substituted or unsubstituted C₁-C₆ alkyl group or a substituted or unsubstituted C₆-C₁₂ aryl group. R₃ can be H, HO, CH₃, or can represent the tethering group covalently binding the linear siloxane molecule or polymer to the substrate edge portion and/or the phosphonate. R₄ represents an end group, and n represents an integer between 2 and about 15,000.

R¹ and R² may be independently selected from the group consisting of H and a substituted or unsubstituted C₁-C₄ alkyl group, more specifically H, methyl, ethyl, n-propyl, and isopropyl. The choice of side groups may influence the hydrophobic and/or omniphobic properties of the silicon-containing coating. In some embodiment, it may be particularly advantageous that R¹ and R² are independently selected from the group consisting of H and an unsubstituted C₁-C₄ alkyl group, more specifically H, methyl, ethyl, n-propyl, and isopropyl, more specifically selected from H, methyl and ethyl.

R³ may represent a tethering group selected from an oxygen containing attachment, a carboxylic group, an amine group, epoxide, or other reactive group. It may also be hydrogen, an alkoxy group such as a methyl, ethyl, propyl, or phenyl group with or without additional attachments. In some embodiments, the carbonaceous residue may be an ester containing group, ether containing group or ketone containing group. In some embodiments, the nitrogenous group may be an amine containing group or an amide containing group. The composition of the tethering group may be analyzed for example by depth profiling using Time-of-Flight Secondary Ion Mass Spectrometry (ToF-SIMS) and X-ray photoelectron spectroscopy (XPS) combined with Ar-GCIB (Gas cluster ion beam) sputtering.

The selection of R⁴ as the end group is not particularly limited. In some cases, it may be the repeat unit where polymerization stopped. In some embodiments, R⁴ representing the end group may be selected from e.g., the group consisting of H, a substituted or unsubstituted C₁ to C₄ alkyl group, a substituted or unsubstituted C₆ to C₁₂ aryl or heteroaryl group and a substituted or unsubstituted silyl or siloxy group. In some embodiments, R⁴ representing the end group may be selected from the group consisting of H, a substituted or unsubstituted alkyl group, a substituted or unsubstituted aryl or heteroaryl group and a substituted or unsubstituted silyl or siloxy group such as a tri-C₁-C₄ alkoxysilyl group or the 3-(2-aminoethyl)aminopropyl-dimethoxysiloxyl group.

The R⁴ may represent the end group may be selected from the group consisting of H, an unsubstituted C₁ to C₄ alkyl group and an unsubstituted C₆ to C₁₂ aryl group.

R⁴ may represent the end group may be selected from the group consisting of H, methyl, ethyl, n-propyl, isopropyl and phenyl.

The symbol n may represent an integer between 4 and about 1000, more specifically, between 8 and 800, even more specifically between about 12 and about 600, and in particular between about 16 and bout 400. Additionally, n may represent an integer between about 4 and about 1000, more specifically between about 8 and about 800, even more specifically between about 12 and about 500, and in particular between about 25 and about 250. A longer chain length may provide improved lubricity, but may also lead to a faster breakdown of the chain.

The plurality of linear silicon-containing compounds may be selected from the group consisting of dimethylsiloxanes or methylhydrosiloxanes. polydimethylsiloxanes, for example a trimethoxy-terminated polydimethylsiloxane, or combinations thereof.

The coating may further comprise crosslinked siloxanes. Such crosslinking may improve the stability of the silicon-containing coating against abrasion. In some embodiments, the degree of such crosslinking should be low, e.g. less than about 10 mol-%, less than about 5 mol-% or less than about 2 mol-% in relation to the linear silicon-containing s, in order to retain the silicon-containing coating's liquid like properties. In some embodiments, the coating may be free or substantially free from crosslinked siloxanes. This may be beneficial in obtaining good lubricating properties, omniphobic properties and/or the aforementioned liquid-like surface.

The coating may be provided on the substrate edge and the substrate sides. The coating may generally follow the surface and contour of the underlying substrate edge portion. The coating may be homogeneous or non-homogeneous, e.g. varying in thickness and/or composition. The coating layer may cover all or a substantial portion of the substrate such as, for example, 100% of the substrate, 95% of the substrate, 90% of the substrate, 85% of the substrate, 80% of the substrate, 75% of the substrate, 70% of the substrate, 65% of the substrate, 60% of the substrate, 55% of the substrate, 50% of the substrate. The coating layer may cover all or a substantial portion of a portion of the substrate such as the first 400 micrometers from the edge, the first 350 micrometers from the edge, 300 micrometers from the edge, the first 250 micrometers from the edge, the first 200 micrometers from the edge, the first 150 micrometers from the edge, the first 100 micrometers from the edge, or the first 500 micrometers from the edge. The coating layer may coat a percentage of a portion of the substrate as measured from the edge created by all the potential combinations disclosed in the immediately preceding two sentences. Last, the coating layer may only be located on one side of the substrate.

The phosphonate polysiloxane coating layer may have an average thickness, measured over an area of about 0.1 mm², of about 5 to about 500 nm, more specifically about 20 to about 150 nm, and in particular of about 30 to about 100 nm, and can be as low as 20 nm. A low thickness may improve the shaving performance of the razor blade by reducing the cutting force.

The thickness may be determined by known techniques such as, e.g., white light reflectance spectroscopy, laser interferometry or three-dimensional laser scanning microscopy ((3D-LSM), ellipsometry, atomic force microscopy;); or for a thickness about 20 nm, e.g. X-ray photoelectron spectroscopy (XPS) combined with Ar-Gas cluster ion beam (GCIB).

In some embodiments, the phosphonate polysiloxane layer may vary in thickness such that that difference in layer thickness may be about 150 nm, more specifically at most about 100 nm, and in particular at most about 50 nm for an area about 0.1 mm². The maximum difference in thickness may be measured by the same methods as described above for measuring the thickness. A uniform thickness may improve the shaving performance of the razor blade.

The coating may have a coefficient of friction between about 0.005 and about 2 more specifically between about 0.01 and about 1, and in particular 0.05 and about 0.5. The method of measuring the coefficient of friction is not particularly limited. The coefficient of friction may be measured for example by using a tribometer or, for instance, a nanotribometer, or a pin-on-disk tribometer.

The phosphonate polysiloxane layer may be hydrophobic to provide a lower chemical interaction with cut hair. phosphonate polysiloxane layer may exhibit a water contact angle of between 90 and about 140°, more specifically between about 100 and about 130°, and in particular between about 105° and about 115°. Alternatively, the phosphonate polysiloxane layer may be omniphobic.

In an embodiment, the phosphonate polysiloxane layer comprises of between 1 and at up to 5 Phosphorus molecules for every 20 Silicone molecules. As shown in FIG. 10, In some embodiments, the initial 10-200 angstroms of the outermost layer 76, nearest the overcoat layer 74, contains nearly all of the phosphonate molecules, while the remaining material above this phosphonate-rich interface layer, is appreciably phosphonate free (P:Si is less than 0.02:1). Silicon atoms can be found throughout the outermost layer 76.

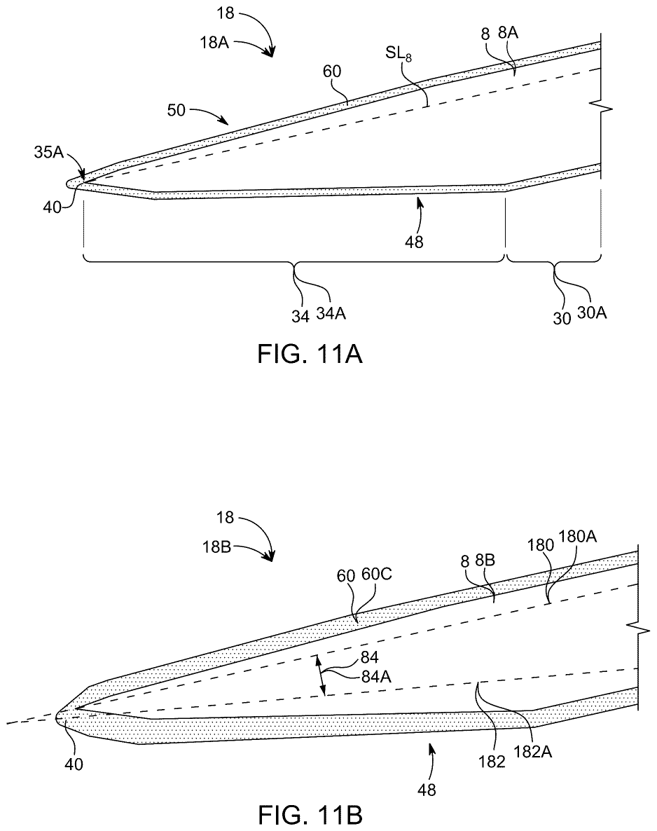

FIGS. 11A and 11B illustrate examples of two distinct razor blades 18,18A and 18B that comprises an asymmetric substrate 8,8A and 8B. With reference to FIG. 11A, the razor blade 18A may comprise a first portion with a blade body 30,30A and a second portion with a tip portion 34,34A, in which the blade body may comprise a base (not shown) and the tip portion 34A may comprise flanks (not labeled) that converge at a sharpened tip 40. The flanks may each comprise one or more bevels or facets (not labeled) that are of unequal length, such that the tip portion 34A is asymmetric. Although the tip portion 34A is depicted as including two facets on each of a first outer side 48 and a second outer side 50, it may be understood that the first and second outer sides 48 and 50 may comprise differing numbers of facets, and in some examples, one of the outer sides, e.g., the second outer side 50, may comprise no facets.

The razor blade 18 may comprise a coating 60 extending along the first and second outer sides 48 and 50 from a tip region 34 toward the base (not shown). As described herein, the first outer side 48 may define a skin-contacting surface, and the second outer side 50 may define a hair-cutting surface. Also as described herein, the coating 60 may be disposed on the tip portion 34 and at least a portion of the blade body 30, as shown in FIG. 11A, or only on the tip portion 34 (not shown;). Although a single layer is depicted for convenience, the coating 60 may comprise an outermost layer and at least one additional layer, as described herein (see FIGS. 5 and 6).

With continued reference to FIG. 11A, the coating 60 may generally conform to and/or mirror an outer shape of underlying portions of the substrate 8A and may comprise a substantially uniform thickness. A split line SL₈ may pass through the tip 40 and may be generally parallel with outer surfaces (not labeled) of the blade body 30. Because the coating 60 generally conforms to an outer shape of the substrate 8A, the split line SL₈ of the substrate 8A may coincide with a centerline (not shown) of the coating 60, as described herein.

With reference to FIG. 11B, the substrate 8,8B may be substantially similar to the substrate 8A in FIG. 8A except that the coating 60,60C is asymmetric, i.e., the coating 60C does not conform to and/or mirror an outer shape of underlying portions of the substrate 8B. The asymmetric coating 60C may comprise a variable thickness that varies along at least a portion of the substrate 8B. The substrate 8B may comprise a split line 180, 180A (also referred to as a centerline) that may be substantially similar to the split line SL₈ shown in FIG. 11A. The asymmetric coating 60C may comprise a centerline 182, 182A that may be offset from the centerline 180A of the substrate 8B, as indicated by 84, 84A. As described above, the centerline 182A of the asymmetric coating 60C may be determined by an angle at which the asymmetric coating 60C is deposited with respect to the centerline 180A of the substrate 8B. In some examples, the centerline 182A of the asymmetric coating 60C may be offset from the centerline 180A of the substrate 8B by at least at least 3 degrees, and in other examples, by at least 8 degrees. In further examples, the centerlines 180A and 182A may be offset by up to 30 degrees. As described above, the asymmetric coating 60C, particularly when an outermost layer (not shown) comprises a phosphonates and siloxanes coating material as described herein, may help to increase shaving comfort and safety, as well as durability.

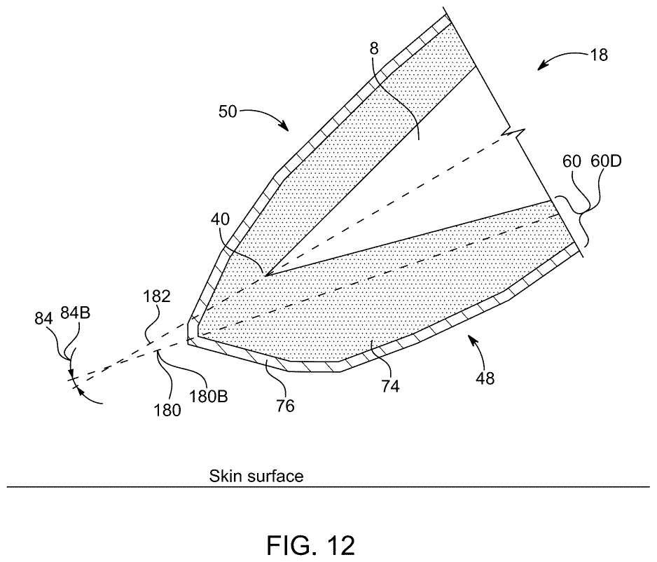

FIG. 12 illustrates an example of a coating 60,60D that does not conform to and/or mirror an outer shape of underlying portions of a substrate 8 (referred to herein as an asymmetric coating). The asymmetric coating 60D may comprise a variable thickness that varies along at least a portion of the substrate 8. The asymmetric coating 60D may comprise at least an outermost layer 76, which may comprise the phosphonates and siloxanes coating material as described herein, and, optionally, one or more additional layers 74, which may comprise one or more of layers 70, 72, and 74 in FIG. 5.

The coatings may be symmetric or asymmetric along a split line as described below and as found in U.S. Pat. No. 11,759,962. The substrate 8 in FIG. 12 may comprise a split line 180,180B (also referred to as a centerline) that passes through a tip 40 and divides or separates the substrate 8 into substantially equal first and second sections or halves (not labeled). The centerline 180 may be generally parallel with generally planar, outer surfaces of a blade body (not shown; see FIGS. 1-4). The asymmetric coating 60D (including the outermost layer 76) may comprise a centerline 182, 182B that may be offset from the centerline 180B of the substrate 8, as indicated by 84,84B. The asymmetric coating 60,60D may be deposited on the substrate 8 at an angle with respect to the centerline 180B of the substrate 8, with the centerline 182B of the asymmetric coating 60D being determined by, for example, the angle at which the asymmetric coating 60D is deposited. In some examples, the centerline 182B of the asymmetric coating 60D may be offset from the centerline 180B of the substrate 8 by at least at least 3 degrees, and in other examples, by at least 5 degrees, by at least 8 degrees, or by at least 10 degrees. In all examples, the centerlines 180B and 182B may be offset by up to 30 degrees. The substrate 8 and asymmetric coating 60D in FIG. 12 are illustrated with respect to a skin surface. As described herein, a first outer side 48 of the substrate 8 may define a skin-contacting surface, and at least a portion of the other outer side, e.g., a second outer side 50, may define a hair-cutting surface. The asymmetric coating 60D, particularly when the outermost layer 76 comprises the phosphonates and siloxanes coating material described herein, may help to increase shaving comfort and safety by reducing cutting forces and improving skin management and may also help to increase durability by reducing shear forces and wear on critical surfaces attributed to peak cutting force of hair (i.e., the hair-cutting surface).

The following specific examples are illustrative of the nature of the present invention. Blades treated in accordance with each of the examples were found by actual shave tests to have remarkably improved shaving characteristics as compared with like blades untreated.

Surface energy may correspond to the cutting force of a cutting member, such as a razor blade. In general, it is desirable to provide a coating material with a relatively low surface energy, while still maintaining a required level of durability to withstand shaving applications.

Surface energies may be determined by a dyne test, in which liquids (e.g., water, diiodomethane, etc.) are applied to a surface and the amount the liquid either spreads out or beads up on the surface is measured for example by measuring the contact angle between the liquid droplet and the surface of the material. For materials with a high surface energy, applied liquid droplets typically spread and form a film on surface of the material. Conversely, for materials with a low surface energy, applied liquid droplets typically form beads.

| | Example | Example | Example | Example | Example | Example |
|---|---|---|---|---|---|---|
| | 1 | 2 | 3 | 4 | 5 | 6 |
| substrate Material | metal | metal | metal | metal | silicon, | silicon, |
| | | | | | diamond | diamond |
| upper surface | Al₂O₃, | Al₂O₃, | Al₂O₃, | Al₂O₃, | nano- | nano- |
| | TiO₂, | TiO₂, | TiO₂, | TiO₂, | crystalline | crystalline |
| | Cr₂O₃, or | Cr₂O₃, or | Cr₂O₃, or | Cr₂O₃, or | diamond, | diamond, |
| | other | other | other | other | silicon | silicon |
| initial coating | vinyl | vinyl | vinyl | alkyl | alkyl | alkenyl |
| | (alkenyl) | phos- | phos- | phos- | phos- | phos- |
| | phos- | phonate | phonate | phonate | phonate | phonate |
| | phonate | | | | | |
| coating 1 | Siloxane | Siloxane | Siloxane | Siloxane | Siloxane | Siloxane |
| | Variant | Variant | Variant | Variant | Variant | Variant |
| cure 1 | UV cure | Thermal | Thermal | UV cure | Thermal | UV cure |
| | 254 nm; | (220°- | (220°- | 176 nm to | (220°- | 176 nm to |
| | 90 hr; | 250° C.) | 250° C.) | 200 nm | 250° C.) | 200 nm |
| | 14 | | | | | |
| | mW/cm² | | | | | |
| ambient 1 | Dry, O₂- | Dry, O₂ | H₂O | Dry, O₂ | Dry, O₂ | Dry, O₂- |
| (cure 1) | free | containing | containing | containing | containing | free |
| | (N₂) | | | | | |
| coating 2 | | | Siloxane | | | |
| | | | Variant | | | |
| cure 2 | | | Thermal | | | |
| | | | (220°- | | | |
| | | | 260° C.) | | | |
| ambient 2 (cure 2) | | | Dry O₂ | | | |
| | | | containing | | | |

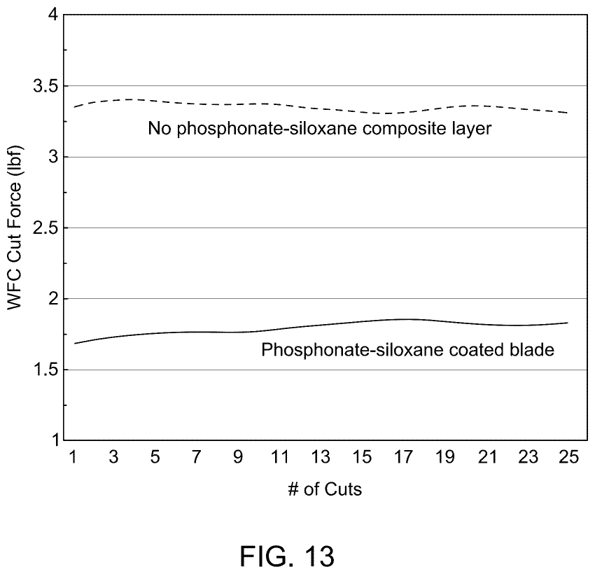

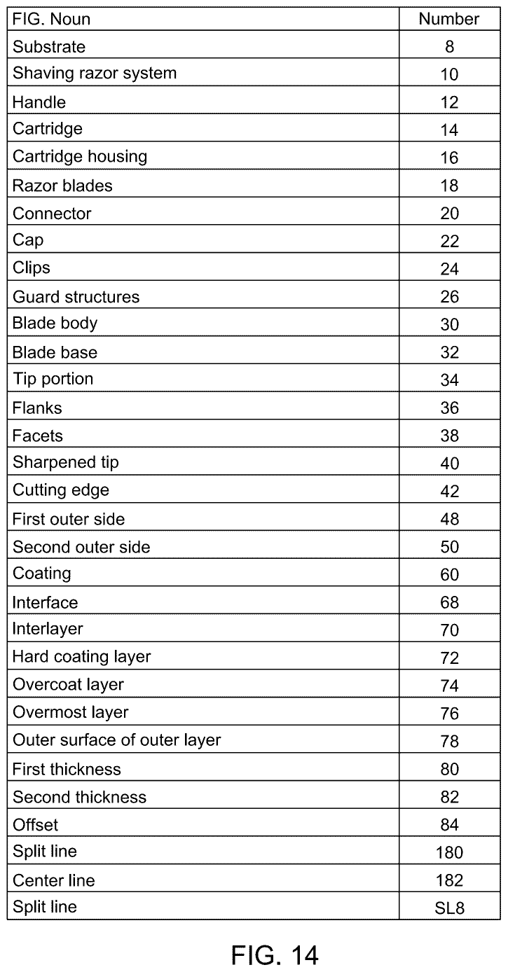

FIG. 13 shows wool cut force data. For this example, blades with a chromium overcoat layer (74) were cleaned using an oxygen plasma for 5 minutes. The blades were then dipped into 100% concentration of vinyl phosphonic acid for 30 minutes at room temperature. Excess vinyl phosphonic acid was washed off using isopropanol in a sonication bath for 30 seconds. The blades were then dried of the isopropanol under a N₂ stream, placed in a vacuum oven at 100° C. for 90 minutes, removed and allowed to cool to room temperature, before being dipped into polyhydromethylsiloxane (DC 1107). These dip coated blades were then placed into a chamber equipped with a UV-C light source and a nitrogen environment, with blade edges facing toward the light source. The blades were exposed to 254 nm UV-C for ˜170 hr. Cured blades were removed, rinsed with isopropanol, and dried with a nitrogen stream prior to cutting into the wool felt. FIG. 13 shows the cutting force behavior, 3 blade average, for blades with a chromium overcoat layer and no phosphonate-siloxane composite layer and for blades with a chromium overcoat layer and a phosphonate-siloxane composite layer (76).
A. A razor blade comprising a substrate and a coating on a portion or all of the substrate, the coating comprising an outermost layer, the substrate comprising a tip portion, a blade body, and a base,
   wherein the tip portion converges at a tip,
   wherein the outermost layer comprises a phosphonate polysiloxane composite layer.
B. The razor blade of paragraph A, wherein the phosphonate polysiloxane composite layer comprises phosphonate and siloxane.
C. The razor blade of any of paragraphs A to B, wherein the phosphonate is selected from the group comprising a non-hydrolysable group such as mercapto, amino, acrylate, carboxyl, alkyl, or vinyl group.
D. The razor blade of any of paragraphs A to C, wherein the siloxane is selected from the group comprising Si—H, Si—OH, or vinyl containing siloxane polymer, including H—, OH—, or vinyl terminated polydimethylsiloxane (PDMS), polymethylhydrosiloxane (PMHS), and PDMS-PMHS copolymers, or combinations thereof.
E. The razor blade of any of paragraphs A to E, wherein the coating is a multi-layer coating, wherein the multi-layer coating further comprises an interlayer, a hard coating layer, and an overcoat layer.
F. The razor blade of paragraph E, wherein the overcoat layer comprises at least one of CrPt, ceramics, metal oxides, cabides, nitrides, borides, and similar oxides, Al-doped ZnO, Cr₂O₃, Al₂O₃, TiO₂, ZrO₂, and combinations thereof.
G. The razor blade of any of paragraphs A to F, wherein the coating comprises less than 1 percent by weight of polytetrafluoroethylene (PTFE) or any other perfluoro- or a polyfluoroalkyl substance (PFAS).
H. The razor blade of any of paragraphs A to G, wherein the coating comprises an overcoat layer and wherein the phosphonate polysiloxane layer exhibits a gradient concentration of phosphonate that is greater at the overcoat interface and lower at the outer surface of the coating.
I. The razor blade of any of paragraphs A to H, wherein at least one of the substrate or the coating is asymmetric in relation to the centerline of the razor blade.
J. The razor blade of any of paragraphs A to I, wherein the substrate tip portion has a thickness of between about 1.0 μm and about 4.0 μm measured at a distance of 4 μm from the tip.
K. A cartridge for a shaving razor system comprising at least one razor blade according to any of paragraphs A to J.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” The use of a letter after a number is used to denote an alternative embodiment of the numbered element.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A cartridge for a shaving razor system comprising at least one razor blade, wherein the at least one razor blade comprises a substrate comprising a tip portion, a blade body, and a base,
wherein the tip portion converges at a tip,
wherein at least a portion of the substrate tip portion, the substrate body, or both the substrate tip portion and the substrate body have a coating comprising an outermost layer, wherein the outermost layer comprises a phosphonate polysiloxane composite layer.

2. The cartridge of claim 1, wherein the phosphonate polysiloxane composite layer comprises a phosphonate and a siloxane.

3. The cartridge of claim 2, wherein the phosphonate is selected from the group comprising a non-hydrolysable group such as mercapto, amino, acrylate, carboxyl, alkyl, or vinyl group.

4. The cartridge of claim 2, wherein the siloxane is selected from the group comprising a Si—H, Si—OH, or vinyl containing siloxane polymer, including H—, OH—, or vinyl terminated polydimethylsiloxane (PDMS), polymethylhydrosiloxane (PMHS), and PDMS-PMHS copolymers, or combinations thereof.

5. The cartridge of claim 1, wherein the coating is a multi-layer coating, wherein the multi-layer coating further comprises an interlayer, a hard coating layer, and an overcoat layer.

6. The cartridge of claim 5, wherein the overcoat layer comprises at least one of CrPt, ceramics, metal oxides, cabides, nitrides, borides, and similar oxides, Al-doped ZnO, Cr₂O₃, Al₂O₃, TiO₂, ZrO₂, and combinations thereof.

7. The cartridge of claim 1, wherein the coating comprises less than 1 percent by weight of polytetrafluoroethylene (PTFE) or any other perfluoro- or a polyfluoroalkyl substance (PFAS).

8. The cartridge of claim 1, wherein the coating comprises an overcoat layer and wherein the phosphonate polysiloxane layer exhibits a gradient concentration of phosphonate that is greater at the overcoat interface and lower at the outer surface of the coating.

9. The cartridge of claim 1 wherein the substrate is asymmetric.

10. The cartridge of claim 1, wherein the substrate tip portion has a thickness of between about 1.0 μm and about 4.0 μm measured at a distance of 4 μm from the tip.

11. The cartridge of claim 1, wherein the coating is asymmetric.

12. A razor blade comprising a substrate and a coating on a portion or all of the substrate, the coating comprising an outermost layer, the substrate comprising a tip portion, a blade body, and a base,
wherein the tip portion converges at a tip,
wherein the substrate tip portion has a thickness of between about 1.0 μm and about 4.0 μm measured at a distance of 4 μm from the tip;
wherein the outermost layer comprises a phosphonate polysiloxane composite layer.

13. The razor blade of claim 12, wherein the phosphonate polysiloxane composite layer comprises phosphonate and siloxane.

14. The razor blade of claim 13, wherein the phosphonate is selected from the group comprising a non-hydrolysable group such as mercapto, amino, acrylate, carboxyl, alkyl, or vinyl group.

15. The razor blade of claim 13, wherein the siloxane is selected from the group comprising Si—H, Si—OH, or vinyl containing siloxane polymer, including H—, OH—, or vinyl terminated polydimethylsiloxane (PDMS), polymethylhydrosiloxane (PMHS), and PDMS-PMHS copolymers, or combinations thereof.

16. The razor blade of claim 12, wherein the coating is a multi-layer coating, wherein the multi-layer coating further comprises an interlayer, a hard coating layer, and an overcoat layer.

17. The razor blade of claim 16, wherein the overcoat layer comprises at least one of CrPt, ceramics, metal oxides, cabides, nitrides, borides, and similar oxides, Al-doped ZnO, Cr₂O₃, Al₂O₃, TiO₂, ZrO₂, and combinations thereof.

18. The razor blade of claim 12, wherein the coating comprises less than 1 percent by weight of polytetrafluoroethylene (PTFE) or any other perfluoro- or a polyfluoroalkyl substance (PFAS).

19. The razor blade of claim 12, wherein the coating comprises an overcoat layer and wherein the phosphonate polysiloxane layer exhibits a gradient concentration of phosphonate that is greater at the overcoat interface and lower at the outer surface of the coating.

20. The razor blade of claim 12, wherein at least one of the substrate or the coating is asymmetric in relation to the centerline of the razor blade.
